(19) United States
(12) Patent Application Publication
(10) Pub. No.: US 2025/0118726 A1
(43) Pub. Date: Apr. 10, 2025

(54) METAL-SEAWATER FLOW BATTERY

(71) Applicant: The Research Foundation for The State University of New York, Amherst, NY (US)

(72) Inventor: Jian-Ping ZHENG, Amherst, NY (US)

(21) Appl. No.: 18/729,461

(22) PCT Filed: Jan. 17, 2023
(86) PCT No.: PCT/US2023/060788

§ 371 Date: Jul. 16, 2024

Related U.S. Application Data
(60) Provisional application No. 63/300,251, filed on Jan. 17, 2022.

(51) Int. Cl. H01M 4/06; H01M 4/02; H01M 4/38; H01M 4/50; H01M 4/583; H01M 6/34

(52) U.S. Cl. CPC H01M 4/06; H01M 4/38; H01M 4/50; H01M 4/583; H01M 6/34; H01M 2004/028

(57) ABSTRACT

A metal-seawater flow battery includes an anode disposed in a non-aqueous electrolyte and a cathode spaced apart from the anode. A metal-ion conductive membrane separates the anode from the cathode. The anode includes active metal. The cathode is configured to receive a flow of seawater therethrough. The cathode may be porous. For example, the cathode may include porous carbon (for example, carbon foam, carbon nanotubes, activated carbon, carbon black, or other forms of porous carbon, or combinations of different forms of porous carbon).

### CROSS-REFERENCE TO RELATED APPLICATIONS

This application claims priority to U.S. Provisional Application No. 63/300,251, filed on Jan. 17, 2022, now pending, the disclosure of which is incorporated herein by reference.

### FIELD OF THE DISCLOSURE

The present disclosure relates to the field of batteries. More specifically, the present disclosure relates to flow batteries, and in particular to metal-water flow batteries or metal-seawater flow batteries.

### BACKGROUND OF THE DISCLOSURE

Li-air batteries or Li-seawater batteries have a lithium metal anode, a porous and electrically conductive cathode, and a Li-ion conductive separator in between anode and cathode. U.S. Pat. Nos. 7,344,804, 9,935,317, 5,427,873, 8,323,817, 3,343,988, 3,005,864, 4,601,961, 9,660,311, and 10,916,753, U.S. Pub. Nos.: 2013/0089796 A1 and 2020/0168876, and International Publication No. WO 1989/011165A1, all have structures that are similar with the structure mentioned above. With respect to the cathode electrode, non-aqueous or aqueous electrolytes have been used. When aqueous electrolytes were used, a solid-state lithium-ion conductive membrane was placed in between the anode and the cathode. Therefore, in the prior art, the cathode electrode was made with one side to be opened to air or seawater for Li-air batteries or Li-seawater batteries, respectively. Typically, a porous hydrophobic membrane was placed at the surface of the cathode to prevent electrolyte loss from the cathode. The advantages of this structure are that discharge products were confined inside the cathode and can be recharged; therefore, such batteries are rechargeable. The disadvantages are 1) the cathode must provide sufficient volume to accommodate the discharge product; this volume must be prefilled with electrolyte that has a high conductivity for Li-ions and allows O₂ diffusion. Because the required electrolyte weight is greater than that of the Li anode, the theoretical energy density will be reduced significantly to about 3,000 for Li-air batteries using non-aqueous electrolyte and 1,400 Wh/kg for batteries using aqueous electrolyte in the cathode; and 2) one of the major disadvantages of Li-air batteries is the low-rate capability due to the low O₂ concentration and diffusivity in the electrolyte. In addition, the low O₂ diffusivity introduces another fundamental limitation on the energy density of these batteries-very limited O₂ diffusion length. In all of the aforementioned prior art, the electrolyte in the cathode does not flow or move.

Flow batteries are also disclosed in U.S. Pat. No. 9,991,545 and International Publication No.: WO 2015/004069. In both publications, the cathode is connected to a water tank to allow the circulation of the aqueous solution through the tank. It is a closed system. The advantage of such systems is that no metal-ion from anode to cathode is lost from the system; therefore, these are rechargeable batteries. The disadvantages are 1) since the system includes the water tank, the energy density of such flow batteries is at least an order of magnitude lower than conventional metal-air batteries; and 2) after the discharge process, the oxygen concentration in the water will decrease, so a mechanism and process to supplement the oxygen in the water is needed, such as the oxygen exchange unit mentioned in U.S. Pat. No. 9,991,545. This will further reduce the energy density of the system.

The rapid growth of portable electronic devices in both military and civilian applications has increased the need for high-energy-density storage devices. In this context, Li-air batteries have attracted much attention due to their extremely high specific capacity, which is due to the use of Li sheet as the anode electrode and O₂ from air as cathodic reactant. Due to the high reactivity of the Li metal, the anode must be operated in non-aqueous electrolytes; however, the cathode can be operated in both non-aqueous and aqueous electrolytes with different electrochemical reactions as shown below:

| | | | |
|---|---|---|---|
| At anode: | 4Li → 4Li⁺ + 4e⁻ | E^{o} = −3.04 V | (1) |

1) For cathode using non-aqueous electrolyte:

| | | | |
|---|---|---|---|
| At cathode: | 4Li⁺ + 4e⁻ + 2O₂ → 2Li₂O₂ | E^{o} = −0.081 V | (2) |
| Overall: | 4Li + 2O₂ → 2Li₂O₂ | E^{o}_{cell} = 2.959 V | (3) |

2) For cathode using aqueous electrolyte:

| | | | |
|---|---|---|---|
| At cathode: | 4Li⁺ + 4e⁻ + O₂ + H₂O → 4LiOH | E^{o} = 0.4 V | (4) |
| Overall: | 4Li + O₂ + 2H₂O → 4LiOH | E^{o}_{cell} = 3.44 V | (5) |

In the case of Li-air batteries with an aqueous electrolyte in the cathode, a solid Li-ion conductive membrane must be used to effectively prevent the crossover of electrolytes.

The theoretical specific capacity of Li is 3,862 mAh/g, which is at least one order of magnitude higher than that of any type of electrode material used in advanced Li-ion batteries.

The theoretical cell voltages of reactions described by Eqs. (3) and (5) are 3.8 and 2.5 V for hydroxide and hydrolysis modes, respectively; therefore, the theoretical maximum energy density based on Li electrode is over or close to 10,000 Wh/kg (5,000 Wh/L). Although the specific capacity and specific energy of Li are smaller than those of hydrogen, Li has a big advantage over hydrogen fuel cells in storage efficiency. Table 1 shows a comparison of Li-air batteries and H₂ fuel cells. The effective specific capacity is based on the theoretical specific capacity and storage efficiency, the specific energy is based on the specific capacity and cell voltage. The weight of O₂ in cathode is not counted because it comes from the atmosphere; however, the weights of the other materials consumed in the cathode such as H₂O are counted. It can be seen from this table that no matter which mode the Li-air batteries work in, the specific energy and energy density are far greater than that of fuel cells.

TABLE 1
Comparison of Li-air batteries and H₂ fuel cells

| | Li-air | Li-air | H₂ Fuel |
|---|---|---|---|
| Characteristics | (Non-aqueous) | (Aqueous) | Cells |
| Anode | Li | Li | H₂ |
| Atomic weight (g/mol) | 6.941 | 6.941 | 1 |
| Mass density (g/cm³) | 0.534 | 0.534 | N/A |
| Specific capacity (mAh/g) | 3,861 | 3,861 | 26,801 |
| Storage efficiency | 80%^{#} | 60%^{#} | 5.5%^{##} |
| Effective specific capacity (mAh/g) | 3,089 | 2,317 | 1,474 |
| Cathode | O₂ (air) | O₂ (air), H₂O | O₂ (air) |
| Atomic weight (g/mol) | N/A | 18*, N/A** | N/A |
| Mass density (g/cm³) | N/A | 1*, N/A** | N/A |
| Specific capacity (mAh/g) | ∞ | 2,987*, ∞** | ∞ |
| Storage efficiency | N/A | 80%*, N/A** | N/A |
| Effective specific capacity (mAh/g) | ∞ | 2,680*, ∞** | ∞ |
| Practical cell voltage (V) | 2.65 | 3.1^{§}, 2.0^{§§} | 0.65 |
| Specific energy (Wh/kg)⁺ | 8,185 | 3,852*, 7,183** | 958 |
| Energy density (Wh/L) | 4,371 | 2,057*, 3,835** | 1089 |

⁺The specific energy is calculated based on anode specific capacity, storage efficiency and practical cell voltage.
^{#}Assume that the weight ratio of Li plate and package materials, and electrolyte is 80:20; the Li plate is 3 mm-thick. Li-air (aqueous) cells contain an additional 150 μm-thick solid Li-ion conducting membrane.
^{##}Assume compressed H₂ in hydrogen tanks at 700 bar.
*Calculated for a closed Li-air (aqueous) cell and
**for a flow battery with infinite capacity.
^{§}Calculated for a Li-air (aqueous) cell operating under hydroxide mode and
^{§§}under hydrolysis mode. The specific energy or energy density under the hydrolysis mode is about 65% of that under the hydroxide mode.

The specific energy and energy density of actual Li-air batteries are much smaller than the theoretical estimations, for several reasons: 1) the cathode must provide sufficient volume to accommodate the discharge product; this volume is prefilled with electrolyte that has a high conductivity for Li-ions and allows O₂ diffusion. Because the required electrolyte weight is greater than that of Li anode, the theoretical energy density will be reduced significantly to about 3,000 Wh/kg for Li-air batteries using a non-aqueous electrolyte and 1,400 Wh/kg for batteries using an aqueous electrolyte in cathode; 2) one of the major disadvantages of Li-air batteries is the low rate capability due to the low O₂ concentration and diffusivity in the electrolyte. In addition, the low O₂ diffusivity introduces another fundamental limitation on the energy density of these batteries as can be shown from the following equation that gives the O₂ diffusion length in the electrolyte:

$$λ = 2 {Fϵ}^{1.5} \frac{{c}_{{O}_{2}} {D}_{{O}_{2}}}{j} \qquad ( 6 )$$

where, F=98,485 C/mol is the Faraday constant, ϵ=0.7 is the porosity of the cathode electrode, cₒ_{₂}=0.2767 mol/m³ is the O₂ concentration, and Dₒ_{₂}=7×10⁻¹⁰ m²/s is the O₂ diffusivity. The above equation shows that the diffusion length (λ) is only about 22 μm when the discharge current density is as low as j=0.1 mA/cm² (and decreases even more when the current density is increased). Therefore, the cathode effective thickness should be of the order of only a few tens of micrometers at a discharge current of 0.1 mA/cm², which will require a Li foil at the anode of about the same thickness. These low effective electrode thicknesses of anode and cathode electrodes not only limit the rate capability but also further reduces the energy density.

The experimental results of Li-air batteries using non-aqueous electrolyte in the cathode have demonstrated that the discharge product of Li₂O₂ is distributed unevenly throughout the cathode. When the battery was fully discharged, the voids at the air side were almost fully filled by the solid Li₂O₂ deposition; however, the voids at the membrane side were still wide open. The solid Li₂O₂ deposition blocked the O₂ diffusion and stopped the discharge. When the cathode used aqueous electrolyte, the distribution of solid discharge product was improved because the LiOH was soluble in water before its concentration reached saturation. But the rate capability was still low due to low O₂ concentration and diffusivity in the cathode.

Li-seawater batteries (LSBs—e.g., similar to that shown in FIG. 1) do not need to use a dedicated electrolyte in the cathode electrode, as they can use seawater which is readily available in maritime applications. Therefore, the theoretically specific energy and energy density of LSBs are higher than that of Li-air (aqueous) batteries. Li-seawater batteries have been proposed with two possible modes. The first mode is the hydroxide mode in which the cathode reaction is given by Eq. (4) and the overall reaction is Eq. (5). This mode of operation is similar to that of Li-air batteries using aqueous electrolyte, except that for a Li-seawater battery, the O₂ diffuses from dissolved O₂ in seawater, while for a Li-air battery, the O₂ needs to dissolve into the water at cathode surface and diffuses to into the cathode electrode. The second mode is the hydrolysis mode in which the reaction products are LiOH and hydrogen gas, as shown below:

| | | | |
|---|---|---|---|
| At cathode: | 2Li⁺ + 2e⁻ + 2H₂O → 2LiOH + H₂↑ | E^{o} = −0.83 V | (7) |
| Overall: | 2Li + 2H₂O → 2LiOH + H₂↑ | E^{o}_{cell} = 2.21 V | (8) |

An advantage of operating the cell in hydrolysis mode is that the maximum current density is not limited by the oxygen concentration and diffusivity; a disadvantage is that the battery requires an additional system to manage the H₂ gas that is being released at the cathode electrode.

However, in the case of Li-seawater batteries, no matter if they operate in the hydroxide or hydrolysis modes, the one-sided cathode opens to seawater to allow oxygen diffusion from outside to inside cathode electrode. The LiOH discharge product is soluble in water and escapes from the cathode. For this reason, Li-seawater batteries are not rechargeable.

### BRIEF SUMMARY OF THE DISCLOSURE

Embodiments of the presently-disclosed metal-seawater flow battery (MSWFB)—for example, the embodiment depicted in FIG. 2—are designed to overcome the disadvantages of Li-air batteries—in particular the low oxygen concentration and diffusivity and the effects of the hydrogen gas accumulation in the cathode. The present MSWFB technology not only greatly increases the maximum discharge power compared to Li-air batteries, but is also capable of reaching its maximum theoretical energy density. Although it is non-rechargeable, the MSWFB has a theoretical specific energy of, for example, over 7,600 Wh/kg (or 4,000 Wh/L).

A difference between traditional metal-seawater batteries and the presently-disclosed metal-seawater flow batteries is that seawater may be pumped continuously into the cathode electrode of the present metal-seawater flow batteries. Since fresh seawater may flow continuously in the cathode electrode, the oxygen concentration in the cathode will always be at its highest value and will remove hydrogen gas produced during the discharge.

Embodiments of the presently-disclosed metal-seawater flow battery (MSWFB) may have following characteristics:
a. The MSWFB is a non-rechargeable battery, because the discharge product (for example, LiOH in a lithium-seawater configuration) is carried out by the seawater stream.
b. The energy density of an MSWFB is primarily determined by the specific capacity of anode (for example, Li metal) and cell voltage. The cathode may be, for example, a porous carbon foam or carbon cloth and does not need to match the capacity of the anode. The overall package efficiency will slightly reduce the energy density of the battery, but this factor can be minimalized. Therefore, the maximum energy density of a Lithium-seawater flow battery (LSWFB) exemplary embodiment is greater than 7,000 Wh/kg (or 4,000 Wh/L) as shown in Table 1.
c. The seawater flow velocity may advantageously be high enough to provide oxygen needed for electrochemical reaction at hydroxide mode or remove H₂ gas generated during the discharge at hydrolysis mode.

In an aspect, a metal-seawater flow battery includes an anode disposed in a non-aqueous electrolyte and a cathode spaced apart from the anode. A metal-ion conductive membrane separates the anode from the cathode. The anode includes active metal. For example, the anode may be made from lithium, sodium, zinc, aluminum, potassium, magnesium, or calcium. The metal-ion conductive membrane corresponds to the anode metal. For example, where the anode is made from lithium, the metal-ion conductive membrane may be made from lithium-ion, and so on for sodium-ion, zinc-ion, aluminum-ion, potassium-ion, magnesium-ion, or calcium-ion.

The cathode is configured to receive a flow of seawater therethrough. In some embodiments, the cathode is made from carbon, nickel, titanium, ruthenium, tantalum, tungsten, copper, stainless steel, or combinations thereof. In some embodiments, the cathode is made from carbon, wherein the carbon is in the form of carbon foam, carbon nanotubes, activated carbon, carbon black, or the like, or combinations thereof. The cathode may be porous. For example, the cathode may have a porosity in a range of 50% to 95%, inclusive. In some embodiments, the cathode is configured as one or more plates spaced apart from the metal-ion conductive membrane at a distance of between of 0.1 to 10 cm, inclusive. In some embodiments, an electrocatalyst is distributed at a surface of the cathode. The electrocatalyst may be α-MnO₂, Ag₂Mn₈O₁₆, gold, or platinum nanoparticles.

In some embodiments, the metal-seawater flow battery includes a pump. The pump may be configured to provide a flow of seawater through the cathode with a flow speed in the range of 0.01 to 10 cm/s, inclusive. The pump may be in fluid communication with seawater having a dissolved oxygen concentration in the range of 2 to 10 mg/L and sodium concentration of >10 g/L.

The metal-seawater flow battery may further include a flow plate configured to guide a flow of seawater. The metal-seawater flow battery may further include a housing. For example, the housing may have an anode side containing the anode and a cathode side containing the cathode. The cathode side of the housing may have an inlet configured to receive a flow of seawater and an outlet configured to discharge the flow of seawater. The metal-ion conductive membrane may separate the anode side of the housing and the cathode side of the housing.

In some embodiments of the metal-seawater flow battery, the non-aqueous electrolyte includes a salt dissolved in a non-aqueous solvent. For example, the salt may include one or more of lithium hexafluorophosphate (LiPF₆), lithium tetrafluoroborate (LiBF₄), lithium perchlorate (LiClO₄), lithium nitrate (LiNO₃), lithium bis (trifluoromethanesulfonyl) imide (LiTFSI), lithium bis (fluorosulfonyl) imide (LiFSI), lithium oxalyldifluoroborate (LiODFB), lithium bis (oxalato) borate (LiBOB), fluoroalkylphosphate (LiFAP), lithium difluoro (oxalato) borate (LiDFOB), sodium hexafluorophosphate (NaPF₄), sodium tetrafluoroborate (NaBF₄), sodium perchlorate (NaClO₄), sodium nitrate (NaNO₃), potassium hexafluorophosphate (KPF₄), potassium tetrafluoroborate (KBF₄), potassium perchlorate (NaClO₄), and potassium nitrate (KNO₃). The solvent may include one or more of ethylene carbonate (EC) and propylene carbonate (PC) (which are able to dissolve sufficient amounts of lithium salt), low viscosity carbonate solvents (such as, for example, ethyl methyl carbonate (EMC), dimethyl carbonate (DMC) and diethyl carbonate (DEC)) for high ionic conductivity, ether solvents and (such as, for example, tetrahydrofuran (THF) dimethoxyethane (DME)).

### DESCRIPTION OF THE DRAWINGS

For a fuller understanding of the nature and objects of the disclosure, reference should be made to the following detailed description taken in conjunction with the accompanying drawings.

FIG. 1 is a diagram showing the operational principles of Li-air batteries. Li-air with aqueous electrolyte need to include a solid membrane to separate the anode from the aqueous electrolyte.

FIG. 2 is a diagram showing the operational principles of Li-seawater batteries. Li-seawater batteries need to include a solid membrane to separate the anode from the aqueous electrolyte.

FIG. 3 shows the discharge time as a function of the Li plate thickness at different discharge current densities. The Coulombic efficiency is assumed to be 100%.

FIG. 4 shows the electrochemical impedance spectra after charge and discharge at 5 mA/cm². The inset shows the equivalent electric circuit used to fit the spectra.

FIG. 5 provides a high-level diagram of the physical structure of (a) a single cell LSWFB and (b) a LSWFB stack with multiple LSWFB cells combined in series.

FIG. 6 shows the oxygen content in fresh and seawater as a function of temperature.

FIG. 7 shows the representative dissolved oxygen profiles for the Pacific and Atlantic oceans.

FIG. 8 is a diagram of a cathode electrode depicting dimensions.

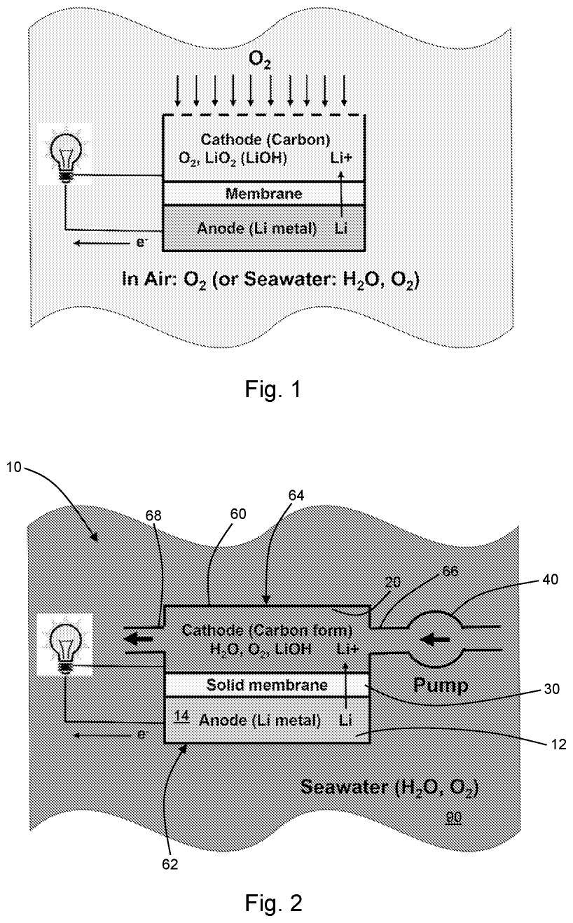

### DETAILED DESCRIPTION OF THE DISCLOSURE

It should be noted that the present disclosure discusses anodes made of lithium solely for convenience and not intended to be limiting in any way. The disclosure is not intended to be, and should not be, limited to lithium anodes. The anodes of the presently-disclosed metal-seawater flow batteries may comprise metals such as, for example, lithium, sodium, zinc, aluminum, potassium, magnesium, or calcium, or combinations or alloys of these. More generally, the anode may comprise an active metal. Active metals are those which have higher activity and are generally alkali metals (e.g., lithium, sodium, potassium), alkaline earth metals (e.g., calcium, magnesium), certain transition metals (e.g., zinc), certain post-transition metals (e.g., aluminum), and/or alloys of two or more of these. For each specific metal, the salt in the electrolyte in the anode, and the solid-state metal-ion conductive membrane will correspond to the metal in the anode electrode. The disclosure herein can be applied to metal anodes other than lithium, and one having skill in the art would only need to make corresponding adjustments which would be apparent in light of the present disclosure.

With reference to FIG. 2, in an aspect, the present disclosure may be embodied as a metal-seawater flow battery 10. The battery 10 includes an anode 12 disposed in a non-aqueous electrolyte 14. A cathode 20 is spaced apart from the anode 12. The cathode 20 is configured to receive a flow of seawater 90 therethrough. In some embodiments, the battery includes seawater, while in other embodiments, the battery is configured for use with seawater but does not include seawater. A metal-ion conductive membrane 30 separates the anode 12 from the cathode 20 (for example, the membrane may be disposed between the anode and the cathode). In some embodiments, the battery 10 includes a pump 40 configured to provide a flow of seawater through the cathode 20. As further described below, the pump may be configured for particular flow rates depending on the cathode configuration. For example, the pump may be configured to provide a flow rate through the cathode in the range of 0.01 to 10 to 100 cm/s, inclusive and all values therebetween (as measured through the cathode).

The anode may comprise an active metal, such as for example, an alkali metal (e.g., lithium, sodium, potassium), an alkaline earth metal (e.g., magnesium, calcium), a transition metal (such as zinc), or a post-transition metal (such as aluminum) or combinations (alloys). The metal-ion conductive membrane may comprise a material selected to correspond to the anode. For example, a lithium-ion membrane may be selected for use with a lithium anode, a sodium-ion membrane may be selected for use with a sodium anode, a zinc-ion membrane may be selected for use with a zinc anode, an aluminum-ion membrane may be selected for use with an aluminum anode, a potassium-ion membrane may be selected for use with a potassium anode, a magnesium-ion membrane may be selected for use with a magnesium anode, and a calcium-ion membrane may be selected for use with a calcium anode.

The anode is disposed in a non-aqueous electrolyte. Such a non-aqueous electrolyte may comprise a salt dissolved in a non-aqueous solvent (e.g., one or more salts dissolved in one or more non-aqueous solvents). Example salt(s) may comprise one or more of lithium hexafluorophosphate (LiPF₆), lithium tetrafluoroborate (LiBF₄), lithium perchlorate (LiClO₄), lithium nitrate (LiNO₃), lithium bis (trifluoromethanesulfonyl) imide (LiTFSI), lithium bis (fluorosulfonyl) imide (LiFSI), lithium oxalyldifluoroborate (LiODFB), lithium bis (oxalato) borate (LiBOB), fluoroalkylphosphate (LiFAP), lithium difluoro (oxalato) borate (LiDFOB), sodium hexafluorophosphate (NaPF₄), sodium tetrafluoroborate (NaBF₄), sodium perchlorate (NaClO₄), sodium nitrate (NaNO₃), potassium hexafluorophosphate (KPF₄), potassium tetrafluoroborate (KBF₄), potassium perchlorate (NaClO₄), and potassium nitrate (KNO₃). Example solvent(s) may comprise one or more of ethylene carbonate (EC) and propylene carbonate (PC) (which are able to dissolve sufficient amounts of lithium salt), low viscosity carbonate solvents (such as, for example, ethyl methyl carbonate (EMC), dimethyl carbonate (DMC) and diethyl carbonate (DEC)) for high ionic conductivity, ether solvents and (such as, for example, tetrahydrofuran (THF) dimethoxyethane (DME)).

The cathode may be made from carbon, nickel, titanium, ruthenium, tantalum, tungsten, copper, stainless steel, or combinations thereof. In the case of carbon cathodes, the carbon may be in the form of carbon foam, carbon nanotubes, activated carbon, carbon black, and the like, or combinations thereof. The cathode may be porous. For example, the cathode may have a porosity in the range of 50% to 95%, inclusive. In embodiments where the cathode is porous, a seawater flow rate may be 0.01 cm/s to 10 cm/s, inclusive, or any value therebetween. In other embodiments, the cathode may be configured as one or more plates. The one or more cathode plates may be spaced apart from the metal-ion conductive membrane by a distance of between 0.1 cm to 10 cm, inclusive, or any value therebetween. In such embodiments, the cathode is configured to receive a flow of seawater therethrough by seawater flowing adjacent to the plates (including, where there are more than one plates, between the plates). In such embodiments, a seawater flow rate may be 0.01 cm/s to 100 cm/s, inclusive, or any value therebetween. The listed seawater flow rates are not necessarily intended to be limiting.

In some embodiments, the battery includes a flow plate to guide the flow of seawater. For example, a flow plate may be provided to guide water through a porous cathode (e.g., prevent the flow of seawater from flowing around the porous cathode.

In some embodiments, the battery includes a housing 60. The housing 60 includes an anode side 62 containing the anode 12, and a cathode side 64 containing the cathode 20. The metal-ion conductive membrane 30 is disposed within the housing 60 to separate the anode side 62 from the cathode side 64. The cathode side 64 of the housing 60 includes an inlet 66 configured to receive a flow of seawater, and an outlet 68 configured to discharge the flow of seawater. In such embodiments, the pump 40 (if included) may be coupled (directly or indirectly) to the inlet 66 or the outlet 68.

In some embodiments, an electrocatalyst is distributed at a surface of the cathode electrode. The electrocatalyst may be, for example, α-MnO₂, Ag₂Mn₈O₁₆, gold, or platinum nanoparticles, or the like.

### FURTHER DISCUSSION AND EXAMPLES

The LSWFB is a non-rechargeable battery, because the discharge product of LiOH is carried out by the seawater stream.

The energy density of the LSWFB is primarily determined by the specific capacity of anode (Li metal) and cell voltage. The cathode may be a porous carbon foam or carbon cloth. The cathode need not match the capacity of the anode. The overall package efficiency will slightly reduce the energy density of the battery, but this factor can be minimalized. Therefore, the maximum energy density of a LSWFB is over 7,000 Wh/kg (or 4,000 Wh/L) as shown in Table 1.

The seawater flow velocity may preferably be high enough to provide oxygen needed for electrochemical reaction at hydroxide mode or to remove H₂ gas generated during the discharge at hydrolysis mode.

### Energy Density

Theoretically, the specific energy of LSWFBs is determined by the specific capacity of Li and open-circuit potential difference between anode and cathode, and is larger or approximately equal to 10,000 Wh/kg (5,000 Wh/L). However, a LSWFB system may also include two current collectors, a solid membrane, a porous carbon as cathode electrode, a small amount of electrolyte in the anode electrode, and additional packaging materials. Part of these materials have the same area as the Li anode including current collectors, solid membrane, cathode electrode. For example, in an embodiment of an LSWFB having a 3 mm-thick Li plate, a 10 μm-thick Cu current collector, a 150 μm-thick solid membrane, a 1 mm-thick porous carbon cathode (70% porosity), and a 10 μm-thick stainless steel current collector, then the specific energy will decrease to approximately 6,000 Wh/kg because of the weight of the above materials. To make a rough estimation of the final specific energy of LSWFB, we further approximate that the casing and packaging of the entire LSWFB will reduce the specific energy by a factor of 50%, so the final specific energy of a LSWFB is above 3,000 Wh/kg. This value is much greater than that of any electrochemical system including hydrogen fuel cells. It will be apparent that the specific energy of LSWFBs with increasing Li thickness in the anode will result in an increase in cell capacity and discharge time. For example, a 3 mm-thick Li anode can be discharged for 360 and 562 hours at the maximum specific powers of 55 and 22 W/kg, respectively, which are about the maximum specific powers for the hydroxide and hydrolysis modes, respectively.

### Power Density

In ordinary Li-air or Li-seawater batteries, the concentration and diffusivity of oxygen in water dominates the maximum current density and maximum specific power of the batteries. The proposed LSWFB fundamentally solves the problem of low oxygen concentration and low diffusivity in cathode electrode by providing a flow of seawater with the oxygen concentration close to the saturated level; therefore, the resistance of the solid Li-ion conducting membrane becomes a main limiting factor for the maximum current density and maximum specific power of a LSWFB. For a state-of-the-art membrane with a resistance of 200 Ω-cm² due to the bulk resistance (˜90 Ω-cm²) and interphase resistances between solid membrane with liquid electrolytes (˜110 Ω-cm²), the maximum current densities are estimated to be 17 and 11 mA/cm² at the hydroxide and hydrolysis modes, respectively. The maximum specific power of LSWFB cells is also estimated to be 55 and 22 W/kg the hydroxide and hydrolysis modes, respectively. It is also found that in order to achieve the maximum current density and maximum specific power, a water flow velocity of about 10 cm/s is needed to provide sufficient oxygen for the reaction as described in Eq. (4) or (5) when the LSWFB operates under hydroxide mode or remove the discharge product of H² from of cathode electrode when the LSWFB operates under hydrolysis mode.

### Energy Efficiency

The energy efficiency of LSWFB is mainly determined by the internal sheet resistance of LSWFB cell and the discharge current density. Internal resistance causes ohmic losses that reduce the output voltage of LSWFBs, thereby reducing energy efficiency. The internal resistance of the LSWFB includes electrical resistances from both electrodes and contact resistances between electrodes and current collectors, resistance of solid electrolyte interphase layer at Li surface, charge transfer resistances at both electrode surfaces, ion diffusion resistance in porous cathode electrode, ionic resistance of solid membrane, and interphase resistances of the solid membrane with liquid electrolytes; however, dominates by the resistance of the solid membrane and associated interphase resistances. For example, the resistance of the solid membrane is about 200 Ω-cm² with a bulk resistance of Rₛ˜90 Ω-cm² and interfacial resistance of Rᵢₙₜ˜110 Ω-cm². The energy efficiency decreases linearly with increasing the discharge current density. When the LSWFB discharges at the maximum specific power, the energy efficiency is 50%.

Finally, additional electric energy may be used to drive the water pump; however, a simple analysis concludes that the required energy to drive the water pump is so small that it can be ignored.

### Example 1

The specific energy of a presently-disclosed LSWFB can be calculated as:

$$ε = \frac{{c}_{L i} {m}_{L i} {V}_{cell}}{{m}_{L i} + {m}_{c} + {m}_{c c} + {m}_{m} + {m}_{p}} = {σ}_{p} \frac{{c}_{L i} {m}_{L i} {V}_{cell}}{{m}_{L i} + {m}_{c} + {m}_{c c} + {m}_{m}} = {σ}_{p} γ {c}_{L i} {V}_{cell} \qquad ( 9 )$$

where c_{Li}=3,861 mAh/g is the specific capacity of Li, m_{Li}, m_{C}, m_{cc}, mₘ, mₚ are the masses of Li plate, carbon foam, current collectors, solid membrane, and package materials, V_{cell} is the cell voltage, and σₚ is the packaging efficiency. In an embodiment where the areas of the carbon foam, current collectors, solid membrane, and Li plate are approximately equal, and assuming their thickness values are those listed in Table 2, the mass ratio γ=m_{Li}/(m_{Li}+m_{c}+m_{cc}+mₘ) is approximately 59%. In addition, in an embodiment where the total weight packaging materials (mₚ) is approximately equal to m_{Li}+m_{c}+m_{cc}+mₘ, the packaging efficiency (σₚ) is 50%.

TABLE 2
Estimated thicknesses of different components in a LSWFB cell

| | | | Mass density | Weight |
|---|---|---|---|---|
| Items | Thickness | | (g/cm³) | (g/cm²) |
| Li anode | 3 | mm | 0.534 | 0.16 |
| Copper foil | 10 | μm | 8.96 | 0.00896 |
| Carbon cathode (70% porosity) | 1 | mm | 2.2 × 30% | 0.066 |
| Stainless steel foil | 10 | μm | 7.8 | 0.0078 |
| Solid membrane | 0.15 | mm | 2.0 | 0.03 |
| Total | 4.17 | mm | | 0.273 |

The cell voltage of an LSWFB depends on the operation mode: 1) in the hydroxide mode, when the oxygen concentration in cathode is high enough to support a reaction of Eq. (5), the reaction agents in the cathode are Li-ions, water, and oxygen and the reaction product is LiOH; 2) in the hydrolysis mode, when the current density increases and the oxygen concentration in the cathode is not enough to support the reaction rate, the reaction agents are Li-ions and water and the reaction products are LiOH and hydrogen gas, as described by Eq. (8). Since the cell voltages for hydroxide (Eq. (5)) and hydrolysis (Eq. (8)) reactions are 3.44 V and 2.21 V, respectively, the specific energy of LSWFBs can be estimated using Eq. (9) to be:

$$ε = 0.5 \times 0.59 \times 3 , 860 mAh / g \times 3.44 V = 3 , 917 Wh / kg \qquad ( 10 )$$

for LSWFB operating in the hydroxide mode and

$$ε = 0.5 \times 0.59 \times 3 , 860 mAh / g \times 2.21 V = 2 , 517 Wh / kg \qquad ( 11 )$$

for LSWFB operating in the hydroxide mode. These values of energy density in LSWFBs are valued for relatively low discharge current; however, there are much higher than the energy density of any existing energy storage system.

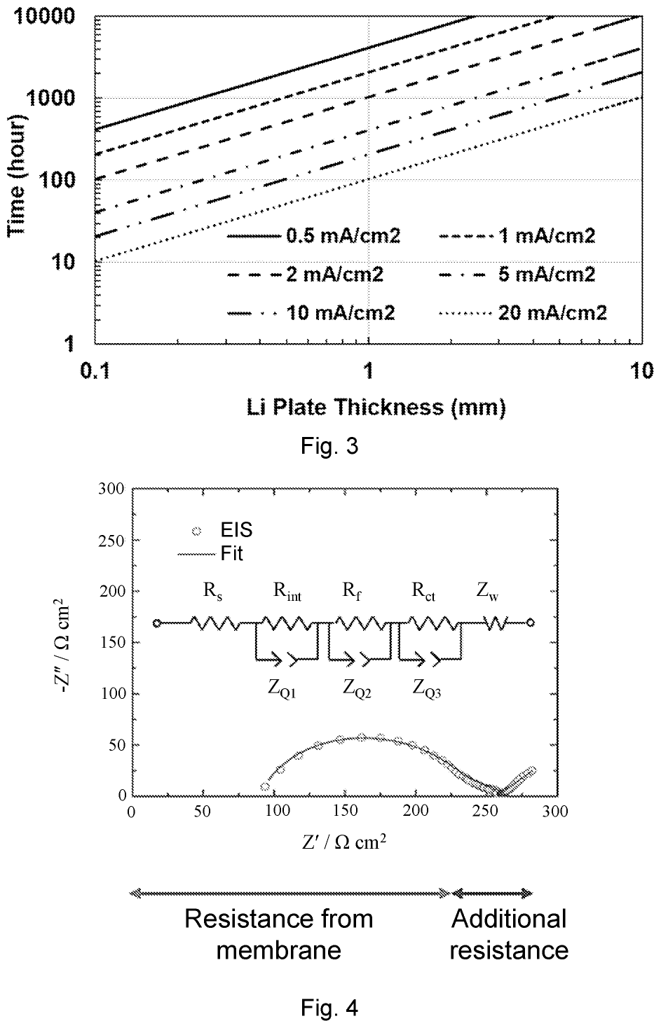

The discharge time can be expressed as a function of Li anode thickness as:

$$T = \frac{t S {ρ}_{L i} F}{{w}_{L i} I} = \frac{t {ρ}_{L i} F}{{w}_{Li} j} \qquad ( 12 )$$

where t is the thickness of Li plate, S is the area of the Li plate, ρ_{Li}=0.534 g/cm³ is the mass density of Li, F=96,485 C/mol=26,801 mAh/mol is the Faraday constant, w_{Li}=6.941 g/mol is the atomic weight of Li, I is the current, and j is the current density. FIG. 3 shows the discharge time as a function of the thickness of Li plate at different discharge current densities.

### Example 2

The power per unit area (W/m²) is:

$$p ( j ) = \frac{I ( {E}_{cell}^{o} - R j )}{S} = j ( {E}_{c e l l}^{o} - R j ) \qquad ( 13 )$$

where I is the discharge current, j is the discharge current density, S is the area of the battery, R is the total internal resistance of the battery unit area (Ω-cm²), and E_{cell}^{o} is the open circuit voltage of the cell. The above equation does not include the faradaic power losses, which can often be neglected in LSWFBs (further described below). The power density has a maximum when the current density is equal to jₘₐₓ=E_{cell}^{o}/2R:

$${p}_{max} = \frac{{( {E}_{c e l l}^{o} )}^{2}}{2 R} \qquad ( 14 )$$

The specific power (W/kg) can be written as:

$$ω = \frac{j ( {E}_{cell}^{o} - R j )}{{m}_{L i} + {m}_{c} + {m}_{c c} + {m}_{m} + {m}_{p}} = \frac{{σ}_{p} Sp ( j )}{{m}_{L i} + {m}_{c} + {m}_{c c} + {m}_{m}} = \frac{{σ}_{p} p ( j )}{{β}_{m}} \qquad ( 15 )$$

where βₘ is the total mass per unit area (see value in Table 2) and σₚ is the packaging efficiency.

The maximum specific power can be obtained when p(j)=pₘₐₓ:

$${ω}_{max} = \frac{{{σ}_{p} ( {E}_{cell}^{o} )}^{2}}{2 R {β}_{m}} \qquad ( 16 )$$

The internal resistance of the cells can be determined using electrochemical impedance spectroscopy (EIS). For instance, FIG. 4 presents the EIS measured for a Li-air flow battery in a frequency range of 0.1-10⁶ Hz. The spectra is fitted using the equivalent electric circuit shown in the inset of FIG. 4. The high frequency intercept of the semicircle on the real axis is reflected by an ohmic resistance (Rₛ), which is predominantly given by the bulk resistance of the solid membrane. The large semicircle in the high frequency range represents combined resistance (Rᵢₙₜ) of the two interfaces of the solid membrane. The small semicircle in the middle frequency range corresponds to (a) the resistance of a passivation film (R_{f}) on the Li electrode surface, and (b) the charge-transfer resistance (R_{ct}). Three constant phase elements (Z_{Q1}, Z_{Q2}, and Z_{Q3}) are in parallel with each resistance. The inclined line in the low frequency range is related to a finite length Warburg element (Z_{w}) arising from a diffusion-controlled process. In the case of LSWFBs, the O₂ diffusion resistance is negligible due to the high circulation speed of the seawater, which is saturated with O₂. The small second semicircle that appear in FIG. 4 indicates a small oxygen diffusion resistance. The fitting values of the equivalent circuit parameters are listed in Table 3. One can notice that the ohmic resistance (Rₛ) is approximately 90 Ω-cm² and the interfacial resistance (Rᵢₙₜ) is around 115 Ω-cm². These values are consistent with previous measurements of the ionic resistance and the interface resistances of the solid-state membrane.

TABLE 3
Fitting parameters of EIS curve fitting.
Values are expressed in Ω-cm².

| Rₛ | Rᵢₙₜ | R_{f} | _{Rct} | R_{w} |
|---|---|---|---|---|
| 89.9 | 115.3 | 34.1 | 19.3 | 144.4 |

The dominating internal resistance of the battery is the internal resistance of the solid membrane, which is R≅200 Ω-cm². This resistance includes (a) the bulk resistance of Rₛ=90 Ω-cm² (˜2×10⁻⁴ S/cm, 200 μm-thick) and (b) the interfacial resistance of Rᵢₙₜ≅115 Ω-cm². It is worth noting that the Li-ion conductivity of the solid membrane is about 100 times lower than the proton conductivity of Nafion membrane used in H₂ fuel cells.

Assuming R=200 Ω-cm² and a packing efficiency of 0.5, the maximum power per unit area and the maximum specific power are:

$${p}_{max} = \frac{{( 3.44 V )}^{2}}{2 \times 200 Ω - {cm}^{2}} = 30 mW / {cm}^{2} \qquad ( 17 )$$

$${ω}_{max} = 55 W / kg$$

for LSWFB operating in the hydroxide mode and

$${p}_{max} = \frac{{( 2.21 V )}^{2}}{2 \times 200 Ω - {cm}^{2}} = 12 mW / {cm}^{2} \qquad ( 18 )$$

$${ω}_{max} = 22 W / kg$$

for LSWFB operating in the hydrolysis mode. The current densities at which these maximum powers are reached are jₘₐₓ=9.5 and 6.25 mA/cm², respectively. These values are more than one order of magnitude higher than in ordinary Li-air batteries.

### Example 3

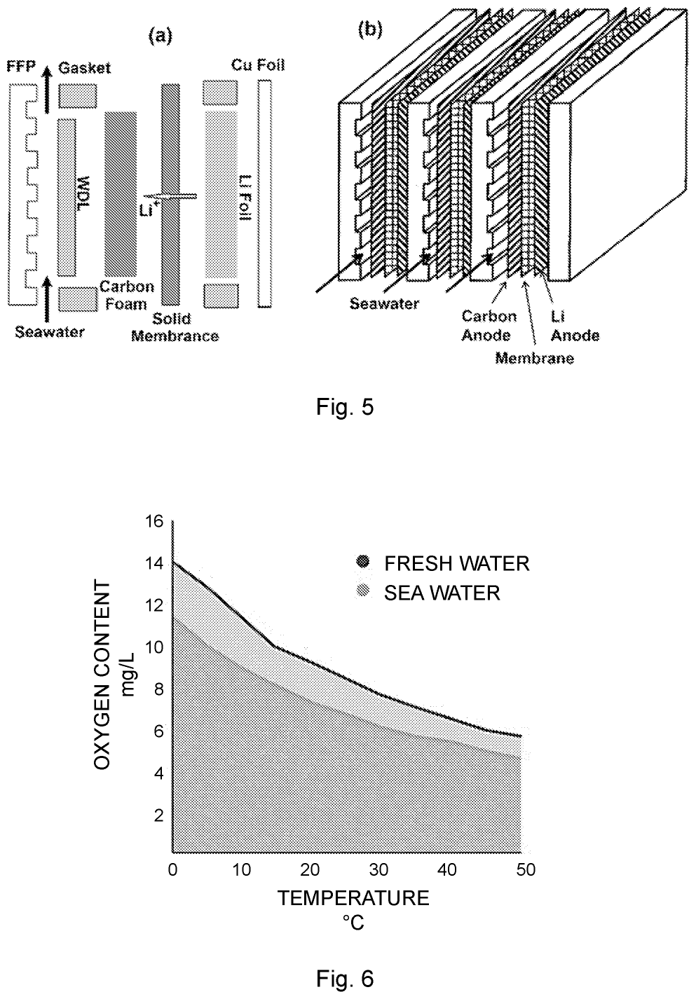

The cathode electrode may allow the continuous flow of seawater through the carbon foam layer. FIG. 5 presents a design that is similar to the configuration of H₂ fuel cells. Flow field plates (FFPs) may be introduced to provide an adequate amount of the reactants (H₂O and O₂) inside the water diffusion layer (WDL) and cathode electrode layer. The most popular channel configurations for fuel cells are serpentine, parallel, and interdigitated flow.

There is much research in the literature related to the design of flow field structures in H₂ fuel cells and it has been generally recognized that the flow field design can have a significant impact on the performance and power density of the cells. However, the published designs have been optimized for fuel cells and may not be directly applied to LSWFBs because there are some fundamental differences between the two types of cells. First, H₂ fuel cells are optimized to allow the flow of gas, while LSWFBs need to be optimized for liquid flow. Second, the flow speeds and viscosity of the fluids in the two types of cells are significantly different. Therefore, for LSWFBs, design features of H₂ fuel cells are redesigned or optimized to improve the water transport and electrochemical properties of LSWFB cells. For instance, a water diffusion layer (WDL) may be added between the flow field plate and the cathode electrode (similar to the gas diffusion layer in fuel cells); however, the thickness, pore size, and porosity of this layer will be optimized for water transport. The WDL will serve as a buffer between the water channels and cathode electrode and will make the water flow more uniformly at the reaction sites.

### Example 4

When an LSWFB operates at hydroxide mode, the maximum current density is limited by the maximum rate at which O₂ can be provided to participate in the hydroxide reaction. The concentration of dissolved O₂ in seawater decreases with the temperature of the water as shown in FIG. 6.

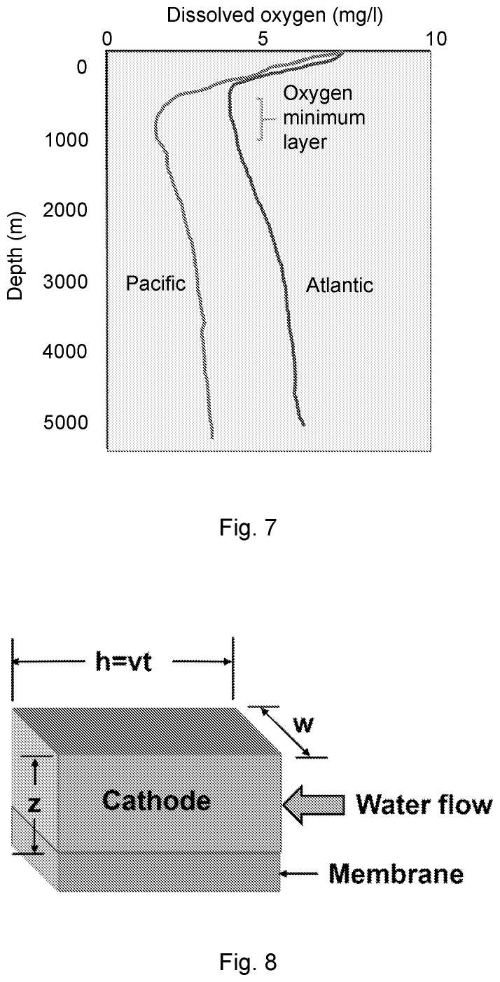

The concentration of dissolved oxygen decreases as salt level increases. For this reason, saltwater holds about 20% less dissolved oxygen than freshwater. In addition, the concentration of dissolved O₂ is different in different oceans and varies with the depth under sea level. FIG. 7 shows the O₂ content at different depths below sea level in the Pacific and Atlantic oceans.

It can be seen from FIGS. 6 and 7 that the dissolved O₂ content is in a range of 2-11 mg/L.

For a given marine environment, the concentration of O₂ in the cathode electrode mainly depends on two factors, one is the current density, because the hydroxide reaction continuously consumes O₂ in the cathode electrode; the other is the flow rate of seawater, because fresh seawater provides new O₂.

The maximum current density is estimated based on the amount of O₂ that flows through the cathode electrode per unit time. Within the cathode volume of U=zwh, where z, w, and h are the thickness, width, and length of the cathode electrode, respectively, as shown in

FIG. 8. The maximum available charge for the hydroxide reaction is:

$$Q = 4 {Fc}_{{O}_{2}} α U \qquad ( 19 )$$

where α is porosity of cathode electrode, F=96,485 C/mol is the Faraday constant, cₒ_{₂} is the concentration of dissolved O₂ (mol/L), and factor 4 appears because each O₂ molecule contributes with 4 element charges as shown in Eq. (3). The maximum current density:

$${j}_{max} = \frac{dQ}{dt} \frac{1}{S} = 4 α {Fc}_{{O}_{2}} \frac{dU}{dt} \frac{1}{S} = 4 α {Fc}_{{O}_{2}} \frac{1}{ρ S} \frac{dM}{dt} \qquad ( 20 )$$

where ρ=1,000 kg/m³ is the mass density of water, dM/dt (kg/s) is the water flow (pump) rate, and =wh is the area of cathode electrode. Therefore, in order to ensure the system supplies enough oxygen to the battery, the minimum water flow that the pump should provide is equal to:

$$\frac{dM}{dt} = \frac{ρ {Sj}_{max}}{4 α {Fc}_{{O}_{2}}} = \frac{ρ {SE}_{cell}^{o}}{8 α {Fc}_{{O}_{2}} R} \qquad ( 21 )$$

For cₒ_{₂}=7.5 mg/L=2.34×10⁻⁴ mol/L, S=10×10 cm², z=1 mm, and a porosity of 0.7, the minimum water flow rate and flow velocity (v) that the pump should provide in order for the cell to operate at the maximum power are:

$$\frac{dM}{dt} \geq \frac{1 g / {cm}^{3} \times 100 {cm}^{2} \times 3.44 V}{8 \times 0.7 \times 96 , 485 C / mol \times 2.34 \times {10}^{- 7} mol / {cm}^{3} \times 200 Ω - {cm}^{2}} = 13.6 g / s \qquad ( 22 )$$

$$v = 13.6 cm / s \qquad ( 23 )$$

### Example 5

When an LSWFB operates in the hydrolysis mode, H₂ gas is generated as a discharge product at a rate of

$$\frac{I}{2 F} = \frac{jwh}{2 F} ( mol / s ) ,$$

where I is the current, j is the current density, wh is the area of cathode electrode, and F=96,485 C/mol is the Faraday constant. The volumetric rate at which H₂ gas is generated (m³/s) is:

$$\frac{{dU}_{{H}_{2}}}{dt} = \frac{jwh}{2 F} {u}_{m} \qquad ( 24 )$$

where uₘ is the molar volume of gas, which is equal to 22.4 L/mol at a pressure of 1 atm and room temperature. The water flow rate (m³/s) is equal to:

$$\frac{{dU}_{{H}_{2} O}}{dt} = {zwv}_{‖} = \frac{zw}{ρ wh} \frac{dM}{dt} = \frac{z}{ρ h} \frac{dM}{dt} \qquad ( 25 )$$

where ρ=1000 kg/m³ is the mass density of water, dM/dt (kg/s) is the water flow (pump) rate, and z is the thickness of the cathode. In order to prevent H₂ gas from accumulating in the cathode electrode, we impose the condition that the water flow rate is larger than the rate at which the H₂ gas is generated:

$$\frac{{dU}_{{H}_{2} O}}{dt} \geq \frac{{dU}_{{H}_{2}}}{dt} \qquad ( 26 )$$

which leads to the following expression for the minimum water flow rate:

$$\frac{dM}{dt} \geq \frac{{j}_{max} ρ {u}_{m} {wh}^{2}}{2 Fz} = \frac{{E}_{cell}^{o} ρ {u}_{m} {wh}^{2}}{4 RFz} \qquad ( 27 )$$

For z=1 mm and a cell area of 10×10 cm², the minimum water flow rate and flow velocity that the pump should provide in order for the cell to operate at the maximum power are:

$$\frac{dM}{dt} \geq \frac{2.21 V \times 1 g / {cm}^{3} \times 22.4 \times {10}^{- 3} {cm}^{3} / mol \times 10 cm \times {( 10 cm )}^{2}}{4 \times 200 Ω - {cm}^{2} \times 96 , 485 C / mol \times 0.1 cm} = 6.4 g / s \qquad ( 28 )$$

$$v = 6.4 cm / s \qquad ( 29 )$$

Eqns. (24), (25), (30), and (31) give estimates of the minimum water flow rate that the pump may provide in order to be able to provide enough oxygen or remove the hydrogen gas from the cathode electrolyte when the LSWFB operates at maximum power density. However, due to the rough approximations that were made while deriving these equations, the minimum flow rate of the pump may be lower or higher. A more accurate value for the minimum flow rate of the pump can be computed using more precise finite element simulations, in which the 2-D or 3-D mass transport equations are coupled with electrochemical equations for the reaction rate and are solved over the entire geometry of the cathode.

### Example 6

The cell voltage drop is determined by two factors, internal sheet resistance (Ω-cm²) of the LSWFB cell and current density (A/cm²). The energy efficiency under discharge current density of j is:

$$ϵ = \frac{{E}_{cell}^{o} - Rj}{{E}_{cell}^{o}} \qquad ( 30 )$$

It can be seen that the energy efficiency decreases linearly with increasing discharge current density and at maximum power density in which jₘₐₓ=E_{cell}^{o}/2R, the energy efficiency is 50%. The electric energy is needed to drive the water pump. The kinetic energy of water is:

$${E}_{W} = \frac{1}{2} {mv}^{2} = \frac{1}{2} ρ {Uv}^{2} \qquad ( 31 )$$

where, m is the mass of seawater in cathode electrode, v is water flow velocity, p is the mass density of seawater, and U=zwh is the cathode volume. The power to pump the water is:

$${P}_{W} = σ \frac{{dE}_{W}}{dt} = \frac{1}{2} σρ {zwv}^{3} \qquad ( 32 )$$

where, σ is pump efficiency and assumes 90%. If the water flow velocities of 13.6 and 6.4 cm/s are used for achieving the maximum specific power under hydroxide (P_{w1}) and hydrolysis (P_{w2}) modes, respectively, the powers required by electric pump are:

$${P}_{W 1} = 0.125 mW \qquad ( 33 )$$

$${P}_{W 2} = 0.0131 mW \qquad ( 34 )$$

It can be seen that the power consumption on the water pump is very small compared with power generation from LSWFB, and can be ignored.

### Example 7

Examples of metals used as anode in metal-seawater flow batteries can be lithium, sodium, zinc, aluminum, potassium, magnesium, or calcium. For each specific metal, the salt in the electrolyte in the anode, and the solid membrane will correspond to the metal in the anode electrode. However, the specific energy of metal-seawater flow batteries using non-lithium metal will be lower. For example, when a sodium (Na)-seawater flow battery (NSWFB) is discharged at hydroxide mode, the electrochemical reactions are sawn as below:

| | | | |
|---|---|---|---|
| At anode: | 4Na → 4Na⁺ + 4e⁻ | E^{o} = −2.71 V | (35) |
| At cathode: | 4Na⁺ + 4e⁻ + O₂ + H₂O → | E^{o} = 0.4 V | (36) |
| | 4NaOH | | |
| Overall: | 4Na + O₂ + 2H₂O → 4NaOH | E^{o}_{cell} = 3.11 V | (37) |

To compare with LSWFB, the open-circuit voltage of NSWFB is about 10% less. With the specific capacity of Na is 1,166 mAh/g, the packaging efficiency is 50%, and mass ratio efficiency as listed in Table 2 to be 72%, the specific energy of NSWFB can be estimated as:

$$ε = 0.5 \times 0.72 \times 1 , 166 mAh / g \times 3.11 V = 1 , 305 Wh / kg \qquad ( 38 )$$

It will be significantly lower than that of LSWFB mainly due to the low specific capacity of Na.

### Further Example

Some embodiments of the presently-disclosed metal-seawater flow battery (MSWFB) include two compartments: the anode compartment, which encloses the metal in non-aqueous electrolyte and the cathode compartment, which contains a porous and electrically conductive materials and seawater. In addition, a solid-state metal-ion conductive membrane is used to separate two compartments. Inlets and outlets for seawater flow channels are installed in the cathode compartment and a mechanical pump is used to control and pump seawater into the compartment. The MSWFB can be operated in two different modes: one is the hydroxide mode that is optimized for high energy density the other one is the hydrolysis mode that is optimized for high power density.

Since seawater flows in the cathode compartment during the entire discharge process, there is no solid precipitation and gas accumulation inside the battery and the entire metal in the anode can be oxidized. Therefore, the MSWFB can achieve a specific energy as high as 10,000 Wh/kg. Also because of seawater flow in cathode, the oxygen consumed due to the discharge reaction can be replenished to maintain a constant oxygen concentration in the cathode which is equal to the concentration of oxygen in the seawater. Therefore, the power density of MSWFB is much greater than that of conventional Metal-air (or O₂) or Metal-seawater batteries. The seawater flow rate plays an important role for balancing the maximum power density and energy efficiency of the MSWFB system.

Although the present disclosure has been described with respect to one or more particular embodiments, it will be understood that other embodiments of the present disclosure may be made without departing from the spirit and scope of the present disclosure.

We claim:

1. A metal-seawater flow battery, comprising:
an anode disposed in a non-aqueous electrolyte, the anode comprising an active metal;
a cathode spaced apart from the anode;
a metal-ion conductive membrane separating the anode from the cathode; and
wherein the cathode is configured to receive a flow of seawater therethrough.

2. The metal-seawater flow battery of claim 1, further comprising a pump configured to provide a flow of seawater through the cathode with a flow speed in the range of 0.01 to 10 cm/s, inclusive.

3. The metal-seawater flow battery of claim 2, wherein the pump is in fluid communication with seawater having a dissolved oxygen concentration in the range of 2 to 10 mg/L, inclusive, and sodium concentration of >10 g/L.

4. The metal-seawater flow battery of claim 1, wherein the anode comprises lithium, sodium, zinc, aluminum, potassium, magnesium, or calcium; and wherein a composition of the metal-ion conductive membrane corresponds to the anode metal (e.g., lithium-ion, sodium-ion, zinc-ion, aluminum-ion, potassium-ion, magnesium-ion, or calcium-ion).

5. The metal-seawater flow battery of claim 1, wherein the cathode is made from carbon, nickel, titanium, ruthenium, tantalum, tungsten, copper, stainless steel, or combinations thereof.

6. The metal-seawater flow battery of claim 5, wherein the cathode is made from carbon.

7. The metal-seawater flow battery of claim 5, wherein the carbon is in the form of carbon foam, carbon nanotubes, activated carbon, carbon black, or combinations thereof.

8. The metal-seawater flow battery of claim 1, wherein the cathode is porous.

9. The metal-seawater flow battery of claim 8, wherein a porosity of the cathode is in a range of 50% to 95%, inclusive.

10. The metal-seawater flow battery of claim 1, wherein the cathode comprises one or more plates spaced apart from the metal-ion conductive membrane at a distance of between of 0.1 to 10 cm, inclusive.

11. The metal-seawater flow battery of claim 1, further comprising a flow plate configured to guide a flow of seawater.

12. The metal-seawater flow battery of claim 1, further comprising a housing comprising:
an anode side containing the anode;
a cathode side containing the cathode, wherein the cathode side of the housing has an inlet configured to receive a flow of seawater and an outlet configured to discharge the flow of seawater; and
wherein the metal-ion conductive membrane separates the anode side of the housing and the cathode side of the housing.

13. The metal-seawater flow battery of claim 1, wherein an electrocatalyst is distributed at a surface of the cathode.

14. The metal-seawater flow battery of claim 13, wherein the electrocatalyst is α-MnO₂, Ag₂Mn₈O₁₆, gold, or platinum nanoparticles.

15. The metal-seawater flow battery of claim 1, wherein the non-aqueous electrolyte comprises a salt dissolved in a non-aqueous solvent.

16. The metal-seawater flow battery of claim 15, wherein the salt comprises one or more of lithium hexafluorophosphate (LiPF₆), lithium tetrafluoroborate (LiBF₄), lithium perchlorate (LiClO₄), lithium nitrate (LiNO₃), lithium bis (trifluoromethanesulfonyl) imide (LiTFSI), lithium bis (fluorosulfonyl) imide (LiFSI), lithium oxalyldifluoroborate (LiODFB), lithium bis (oxalato) borate (LiBOB), fluoroalkylphosphate (LiFAP), lithium difluoro (oxalato) borate (LiDFOB), sodium hexafluorophosphate (NaPF₄), sodium tetrafluoroborate (NaBF₄), sodium perchlorate (NaClO₄), sodium nitrate (NaNO₃), potassium hexafluorophosphate (KPF₄), potassium tetrafluoroborate (KBF₄), potassium perchlorate (NaClO₄), and potassium nitrate (KNO₃).

17. The metal-seawater flow battery of claim 15, wherein the solvent comprises one or more of ethylene carbonate (EC) and propylene carbonate (PC), low viscosity carbonate solvents (e.g., ethyl methyl carbonate (EMC), dimethyl carbonate (DMC) and diethyl carbonate (DEC)), ether solvents (e.g., tetrahydrofuran (THF) dimethoxyethane (DME)).
